(19) United States
(12) Patent Application Publication
(10) Pub. No.: US 2021/0261823 A1
(43) Pub. Date: Aug. 26, 2021

(54) MULTI-CORE FERRULE POLISHING MATERIAL

(71) Applicant: ADMATECHS CO., LTD., Miyoshi-shi (JP)

(72) Inventor: Yusuke TOMIOKA, Miyoshi-shi (JP)

(73) Assignee: ADMATECHS CO., LTD., Miyoshi-shi (JP)

(21) Appl. No.: 17/318,025

(22) Filed: May 12, 2021

Related U.S. Application Data
(63) Continuation of application No. PCT/JP2019/044227, filed on Nov. 12, 2019.

(30) Foreign Application Priority Data
Nov. 13, 2018 (JP) 2018-213187

(51) Int. Cl. C09G 1/02; C09K 3/14

(52) U.S. Cl. CPC C09G 1/02; C09K 3/14

(57) ABSTRACT

To provide a multi-core ferrule polishing material suitable for polishing a multi-core ferrule. A multi-core ferrule polishing material of the present invention addressing the above problem includes a binder formed from a resin material, and abrasive grains dispersed in the binder. The abrasive grains are contained in an amount of not less than 88.5% with respect to a sum of masses of the abrasive grains and the binder, include particles having a particle diameter of not greater than 100 nm, the particles being present in an amount of not less than 70% and less than 100% with respect to the mass of the abrasive grains, and are formed from silica.

### CROSS REFERENCE TO RELATED APPLICATIONS

The present application is a Continuation Application of International Application No. PCT/JP2019/044227, filed on Nov. 12, 2019, which is incorporated herein by reference. The present invention is based on Japanese Patent Application No. 2018-213187, filed on Nov. 13, 2018, the entire contents of which are incorporated herein by reference.

### BACKGROUND OF THE INVENTION

### 1. Field of the Invention

The present invention relates to a multi-core ferrule polishing material to be used in polishing an end face of a multi-core ferrule collectively holding a plurality of optical fibers.

### 2. Description of the Related Art

In recent years, in association with demands for larger capacities and higher efficiencies, optical fibers used as transmission means for optical communication are required to have as little optical loss as possible. For connection of an optical fiber and another optical fiber, an optical connector is used. The optical connector has a ferrule. The ferrule has formed therein an insertion hole into which an optical fiber is inserted. The optical fiber is fixed to the ferrule with an adhesive or the like.

The quality of the connection end face of the optical connector influences optical characteristics of the optical fiber and thus is very important. Therefore, the optical connector end face is subjected to mirror-processing through a plurality of stages of polishing. As final finishing of the polishing, precision mirror polishing using a polishing material, such as a polishing sheet, a polishing tape, a polishing grinding stone, or a polishing cloth, including a polishing layer containing fine abrasive grains, is performed (JP2008001803(A)).

### SUMMARY OF THE INVENTION

Meanwhile, in order to realize large capacities of optical fibers, a multi-core optical fiber composed of a plurality of optical fibers has been developed. For connection of the multi-core optical fiber, a multi-core ferrule is used, and the end face thereof is required to be mirror-finished with still higher precision.

The present invention has been completed in consideration of the above circumstances. A problem addressed by the present invention is to provide a multi-core ferrule polishing material suitable for polishing a multi-core ferrule.

When a multi-core ferrule is polished, the heights of a plurality of optical fibers are desired to have values greater than a predetermined value and to be uniform after the polishing, and realization of a uniform polished state with little polishing is required. In addition, inhibition of generation of a core dip of each optical fiber is required, and no scratch on the polished surface is also required.

These requirements are contradictory to each other. The present inventors conducted thorough studies in order to solve the above problems. As a result, the present inventors solved the problem regarding the height of the optical fiber by containing abrasive grains having a small particle diameter, and the problem of inhibition of the core dip by adopting silica as the abrasive grains. In addition, the surface was found to be polished without causing scratches, by increasing the amount of the abrasive grains and containing abrasive grains of a certain size. That is, the present inventors found that suitable ranges are present for the type and the amount of the abrasive grains to be contained in the polishing material and completed the following invention.

That is, a multi-core ferrule polishing material of the present invention solving the above problems includes a binder formed from a resin material, and abrasive grains dispersed in the binder. The abrasive grains are contained in an amount of more than 88.5% with respect to a sum of masses of the abrasive grains and the binder, include small-diameter particles being particles having a particle diameter of not greater than 100 nm, the small-diameter particles being present in an amount of not less than 70% and less than 100% with respect to the mass of the abrasive grains, and are formed from silica.

Preferably, the small-diameter particles are particles having a peak top particle diameter of not greater than 50 nm. Control in the range further facilitates realization of a uniform optical fiber height.

Further, preferably, the abrasive grains include particles having a peak top particle diameter of not less than 120 nm. Accordingly, a state where the polished surface is without scratches is easily established.

Since the multi-core ferrule polishing material of the present invention has the above configuration, a multi-core ferrule obtained by applying the multi-core ferrule polishing material of the present invention in polishing the multi-core ferrule exhibits high performance.

### DESCRIPTION OF THE EMBODIMENTS

A multi-core ferrule polishing material of the present invention will be described in detail on the basis of an embodiment. A multi-core ferrule polishing material of the present embodiment is a member for polishing an end face of a multi-core ferrule. The multi-core ferrule collectively holds a plurality of optical fibers, and is a member forming an optical connector that connects optical fibers.

The multi-core ferrule polishing material of the present embodiment includes abrasive grains, a binder, and other necessary members.

The abrasive grains are contained in an amount of more than 88.5%, preferably not less than 89.5%, and particularly preferably not less than 90%, with respect to the sum of the masses of the abrasive grains and the binder.

The abrasive grains are formed from silica. A material other than silica may be mixed. However, the amount of silica is, with respect to the mass of the entirety of the abrasive grains, preferably not less than 95%, more preferably not less than 97.5%, and further preferably not less than 99%. A material other than silica may be contained as particles other than the particles made of silica, or may be contained in the same particles made of silica.

As for the abrasive grains, a particle size distribution is specified. Specifically, with respect to the mass of the entirety of the abrasive grains, small-diameter particles are present in an amount of not less than 70% and less than 100%. As a lower limit of the existence amount of the small-diameter particles, 75%, 80%, 85%, 90%, 95%, or 98% may be adopted. The small-diameter particles are particles having a particle diameter of not greater than a certain particle diameter. The particles having the certain particle diameter are particles having a particle diameter of not greater than 0.1 μm, more preferably not greater than 30 nm, and further preferably not greater than 20 nm. Preferably, the small-diameter particles have a peak top at a particle diameter of not greater than the above-described certain particle diameter. A peak top corresponds to the presence of a peak in a particle size distribution expressed in terms of volume, and the particle diameter of the peak top indicates the particle diameter at the peak. Preferably, the particle diameter of the peak top is a mode diameter in a range of particle diameters of not greater than a certain particle diameter. The particle diameter of the peak top of the small-diameter particles is preferably not greater than 50 nm, more preferably not greater than 30 nm, and further preferably, not greater than 20 nm.

The form of the abrasive grains is not limited in particular, but spherical silica having a spherical shape or crushed silica in a crushed form may be adopted. In addition, particles having a particle diameter of not less than 100 nm are preferably contained. In particular, preferably, the particles have a peak top, and the particle diameter at the peak top thereof is preferably not less than 120 nm, more preferably not less than 150 nm, and further preferably not less than 200 nm. Furthermore, in order to inhibit scratches on the polished surface, not containing particles having a particle diameter of not less than 5 μm is desirable.

Herein, the “particle diameter” is a value measured by a combination of a laser diffraction/scattering type particle size distribution measuring device (LA-750: manufactured by HORIBA, Ltd.) and a dynamic light scattering type nanotrack particle size analyzer (UPA-EX150: manufactured by Nikkiso Co., Ltd.).

Specifically, using the laser diffraction/scattering type particle size distribution measuring device, a fluid obtained by dropping several drops of a slurry is subjected to flow cell measurement in a 700 mode, to measure a range where particle diameters are large. Using the dynamic light scattering type nanotrack particle size analyzer, batch measurement is performed in a state of dispersion in methyl ethyl ketone, to confirm particle diameters of particles having a particle diameter of not greater than 100 nm. The measurement results are combined with each other, whereby the particle size distribution is measured.

Spherical silica is produced by reacting metal silicon with oxygen. According to the production method in which metal silicon is reacted with oxygen, spherical silica having an average particle diameter of about 0.05 μm to 10 μm is easily obtained.

Crushed silica is fine particles producible by crushing silica. In terms of the feature of appearance, crushed silica has a rugged surface. In particular, silica in a form obtained by crushing the above-described spherical silica is preferably adopted. The crushing method is not limited in particular. Examples thereof include a bead mill, a jet mill, a ball mill, and a vibratory ball mill.

As the binder, a resin material is adopted. Examples thereof include a resin material obtained by hardening an epoxy resin, a urethane resin, or the like with a hardening agent or the like. The above-described abrasive grains are dispersed into the binder to form a polishing layer.

An example of another necessary member includes a support base member. When a film-shaped member is adopted as the support base member, and a polishing layer composed of the abrasive grains and the binder is formed on the surface thereof, a film-shaped multi-core ferrule polishing material is provided. Moreover, a support base member in an appropriate form other than the film shape may be adopted, and when a polishing layer composed of the abrasive grains and the binder is formed on the surface thereof, a multi-core ferrule polishing material having an intended form is obtained. Further, a multi-core ferrule polishing material is also formed without the support base member, i.e., only as a combination of the abrasive grains and the binder.

The material forming the support base member only needs to have necessary elasticity and necessary strength to hold the polishing layer. For example, a film or the like formed from polyester such as polyethylene terephthalate (PET) or polybutylene terephthalate, polycarbonate, or the like is suitable. When a film having a thin-film shape is adopted as the support base member, the thickness thereof is not limited in particular, and examples thereof include about 25 to 150 μm.

In accordance with a purpose such as improvement of adhesiveness between the support base member and the polishing layer, patterning on the surface of the polishing layer, or the like, a buffer layer may be formed on the surface of the support base member in advance. For example, an easy adhesion layer to serve as a buffer layer may be formed on the support base member surface. The support base member surface may be subjected to heat treatment, corona treatment, plasma treatment, or the like, to form a buffer layer. For example, the easy adhesion layer is formed by applying a buffer coating formed from an epoxy resin, an acrylic resin, a polyester resin, or the like on the support base member surface, and drying the buffer coating.

Method for Producing Multi-Core Ferrule Polishing Material

The multi-core ferrule polishing material of the present embodiment is produced by appropriately dispersing the abrasive grains in the binder. As for dispersion of the abrasive grains, the abrasive grains may be kneaded together with a resin material forming the binder, or may be mixed/dispersed in a precursor such as a monomer/prepolymer that has not yet become the resin material and then is reacted to be the resin material. In particular, preferably, the abrasive grains are dispersed into an organic solvent in advance to form a slurry, and then the slurry is mixed/dispersed into the binder. In this case, as the organic solvent adopted as a dispersion medium, a solvent that dissolves the resin (or a precursor thereof) forming the binder, or an organic solvent capable of being mixed with the precursor is preferably adopted.

When a mixture of the precursor and the abrasive grains is applied on the surface of the above-described support base member and then the precursor is reacted, a polishing layer is formed on the surface of the support base member.

The method for obtaining silica particles forming the abrasive grains is not particularly limited. However, a general method such as a method of reacting metal silicon with oxygen, a method of melting silica by heat, or a sol-gel method may be adopted. In particular, a combination of the method of reacting metal silicon with oxygen and the sol-gel method is preferable.

### EXAMPLES

Preparation of Sample

Sample 1: having a Content of Small-Diameter Particles being 98%

Silica particles, as small-diameter particles, having a particle diameter of not greater than 100 nm and a peak top (mode diameter) of not greater than 50 nm, and silica particles having a volume average particle diameter of 200 nm and substantially not containing coarse grains of not less than 3 μm were mixed such that the content of the small-diameter particles was 98% with respect to the mass of abrasive grains. Then, the mixture was mixed with a carbamate-based monomer serving as a precursor of a resin material forming a binder, to obtain a slurry. The obtained slurry was applied on a surface of a PET resin plate having a thickness of 75 μm, such that the thickness of the slurry was not greater than 20 μm, to obtain a polishing material of Sample 1. The amounts of the abrasive grains in the produced polishing materials of Sample 1 were 88.5%, 89.0%, 89.5%, 90.0%, and 90.5% with respect to the sum of the masses of the abrasive grains and the binder.

Sample 2: having a Content of Small-Diameter Particles being 75%

A polishing material of Sample 2 was produced by a method similar to that in Sample 1 except that the content of the small-diameter particles was 75%.

Sample 3: having a Content of Small-Diameter Particles being 70%

A polishing material of Sample 3 was produced by a method similar to that in Sample 1 except that the content of the small-diameter particles was 70%.

Sample 4: having a Content of Small-Diameter Particles being 90%

A polishing material of Sample 4 was produced by a method similar to that in Sample 1 except that the content of the small-diameter particles was 90%.

Sample 5: having a Content of Small-Diameter Particles being 100%

A polishing material of Sample 5 was produced by a method similar to that in Sample 1 except that the content of the small-diameter particles was 100%.

Sample 6: Adopting Ceria as Abrasive Grains

A polishing material of Sample 6 was produced by a method similar to that in Sample 1 except that ceria having a volume average particle diameter of 10 nm was singly adopted as the abrasive grains.

Sample 7: having a Content of Small-Diameter Particles being 65%

A polishing material of Sample 7 was produced by a method similar to that in Sample 1 except that the content of the small-diameter particles was 65%.

Evaluation

An end face of a multi-core ferrule was polished by using the polishing material of each sample. A multi-core ferrule having four cores was adopted.

Each test polishing film was attached to a polishing machine (ATP-3000 (manufactured by NTT-AT)), distilled water was dropped on the polishing film, and the multi-core ferrule was polished. The polishing condition was 30 seconds at a predetermined pressure.

Evaluation of the end face of the optical connector was performed after cleaning. As pretreatment before the polishing, polishing was performed using a 1 μm diamond polishing sheet for 30 seconds under a predetermined pressure.

With respect to the polished multi-core ferrule, the core dip, the fiber height (average value), the fiber height (difference between maximum value and minimum value), the difference in height of an adjacent fiber, and the end face state were evaluated.

Core Dip

Except for Sample 6 using ceria as the abrasive grains, the values were not greater than 10 nm.

Fiber Height (Average Value)

With respect to all of Samples 1 to 5 each having a content of the small-diameter particles being not less than 70%, the values were not less than 1000 nm. With respect to Sample 7 having a content of the small-diameter particles being less than 70%, the value was about 300 nm, which was less than 1000 nm. A tendency in which the fiber height was increased in accordance with increase in the content of the small-diameter particles was observed.

Variation in Fiber Height (Difference Between Maximum Value and Minimum Value)

With respect to all of Samples 1 to 5 each having a content of the small-diameter particles being not less than 70%, the values were not greater than 500 nm. With respect to Sample 7 having a content of the small-diameter particles being less than 70%, the value was about 600 nm, which was greater than 500 nm. A tendency in which the variation in fiber height was reduced in accordance with increase in the content of the small-diameter particles was observed (the same as above).

Difference in Height of Adjacent Fiber

With respect to all of Samples 1 to 5 each having a content of the small-diameter particles being not less than 70%, the values were not greater than 300 nm. With respect to Sample 7 having a content of the small-diameter particles being less than 70%, the value was 380 nm, which was greater than 300 nm. A tendency in which the difference in height of an adjacent fiber was reduced in accordance with increase in the content of the small-diameter particles was observed (the same as above).

End Face State

With respect to the samples, among Samples 1 to 5, having a content of the abrasive grains being not less than 89.5%, the number of scratches were all 0. When the content of the abrasive grains was 89.0%, the average of the numbers of scratches was 1, and when the content of the abrasive grains was 88.5%, the average of the numbers of scratches was 4.

Summary

The results above revealed that adopting silica as a main component of the abrasive grains is effective in order to decrease the value of the core dip, and that setting the content of the small-diameter particles to be a large value of not less than 70% is preferable in order to realize preferable values of the fiber height and the variation thereof.

In a case where the content of the small-diameter particles is not 100% and a certain amount of abrasive grains having large particle diameters are contained (Sample 1: having a content of the small-diameter particles being 98%), the ferrule end face state was found to be improved when compared with Sample 5 having a content of the small-diameter particles being 100%. Further, the result of Sample 1 revealed that the ferrule end face state was also improved by setting the content of the abrasive grains to be not less than 89.5%.

What is claimed is:

1. A multi-core ferrule polishing material comprising:
a binder formed from a resin material; and
abrasive grains dispersed in the binder, wherein the abrasive grains
are contained in an amount of more than 88.5% with respect to a sum of masses of the abrasive grains and the binder,
include small-diameter particles being particles having a particle diameter of not greater than 100 nm, the small-diameter particles being present in an amount of not less than 70% and less than 100% with respect to the mass of the abrasive grains, and
are formed from silica.

2. The multi-core ferrule polishing material according to claim 1, wherein
the small-diameter particles are particles having a peak top particle diameter of not greater than 50 nm.

3. The multi-core ferrule polishing material according to claim 1, wherein
the abrasive grains include particles having a peak top particle diameter of not less than 120 nm.

4. The multi-core ferrule polishing material according to claim 2, wherein
the abrasive grains include particles having a peak top particle diameter of not less than 120 nm.
